(19) United States
(12) Patent Application Publication
(10) Pub. No.: US 2005/0265030 A1
(43) Pub. Date: Dec. 1, 2005

(54) Anti-glare lamp shade

(75) Inventor: Yun Pin Yang, Lujushiang (TW)

Correspondence Address: TROXELL LAW OFFICE PLLC, SUITE 1404, 5205 LEESBURG PIKE, FALLS CHURCH, VA, 22041, US

(73) Assignee: Exploit Technology Co., Ltd.

(21) Appl. No.: 10/852,193

(22) Filed: May 25, 2004

(51) Int. Cl. F21V 11/00; F21V 9/00

(52) U.S. Cl. 362/359; 362/355; 362/293

(57) ABSTRACT

An anti-glare device mounted around one or more light sources in the shade of a lamp is provided. The device comprises a substrate formed of transparent plastic, and two optical layers formed on inner and outer surfaces of the substrate respectively. The device can substantially eliminate reflections and glare and thus provide a sufficient while subtle lighting to a reading area.

### BACKGROUND OF THE INVENTION

1. Field of the Invention

The present invention relates to anti-glare devices and more particularly to an anti-glare device mounted between lamps and shade of a light (e.g., table lamp) for providing an optimum lighting.

2. Description of Related Art

It is frequently that a computer user may focus his/her eyes on the screen for a long period of time. This can cause eye fatigue. Further, glare may occur on the screen from overhead lights and windows. These factors can deteriorate eyesight. For the annoying, undesired glare, it can be classified as contrast glare, direct glare, or reflective glare (i.e., reflection). The latter two factors can be reduced to a minimum if a light (e.g., table lamp) is well designed. Reflections are frequently occurred when an angle of incident light is equal to a reflecting angle thereof.

Sunglasses are able to protect the eyes from the sun's glare by employing the principles of polarizer. However, a person wearing a pair of sunglasses may see a darker view because about half of light (i.e., parallel light) is eliminated. As such, the principles of polarizer cannot be employed in the improvement of lamps.

Recently, there is a type of lamp shade in the form of diffusive, reflective filter. It is advantageous for substantially eliminating reflections but it cannot eliminate direct glare. Moreover, it can undesirably reduce luminance. Hence, a need for improvement exists.

### SUMMARY OF THE INVENTION

It is an object of the present invention to provide an anti-glare lamp shade so as to substantially eliminate reflections and glare and thus providing a sufficient while subtle lighting to a reading area.

To achieve the above and other objects, the present invention provides an anti-glare device mounted around one or more light sources in a shade of a lamp, comprising a substrate formed of transparent plastic; and two optical layers formed on inner and outer surfaces of the substrate respectively.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of anti-glare device according to the invention;

FIG. 2 is a sectional view of the device in FIG. 1;

FIG. 2A is a detailed view of the area in circle 2A in FIG. 2;

FIG. 3 is a perspective view of the device mounted between lamps and shade of a table lamp;

FIG. 4 is an exploded view of the upper portion of the table lamp in FIG. 3;

FIG. 5 is a side plan view of the upper portion of the table lamp in FIG. 3; and

FIG. 6 is a side plan view illustrating the paths of rays of light when the lamp in FIG. 3 is turned on.

### DETAILED DESCRIPTION OF THE PREFERRED EMBODIMENTS

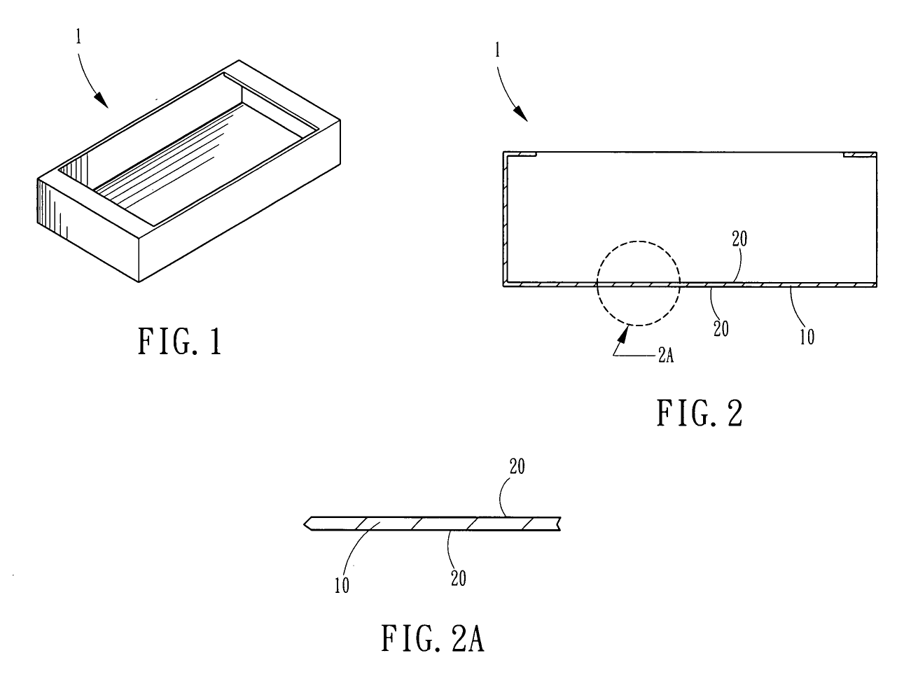

Referring to FIGS. 1 to 2A, there is shown an anti-glare device 1 constructed in accordance with the invention. The device 1 is formed in the shape of a thin parallelepiped container having an open top. The device 1 comprises a substrate 10 and two optical layers 20 formed on inner and outer surfaces of the substrate 10. The substrate 10 is formed of heat-resistant, transparent plastic and has an operating temperature about 180° C. The plastic can be PET (polyethylene telephthalate), PC (polycarbonate), teflon, or acrylic. The optical layer 20 is coated, sprayed, UV (ultraviolet) impinged, or printed on the substrate 10. For the printing, it can be embossed printing, intaglio process, or stencil printing. The formed device 1 is thus able to eliminate glare and reflections.

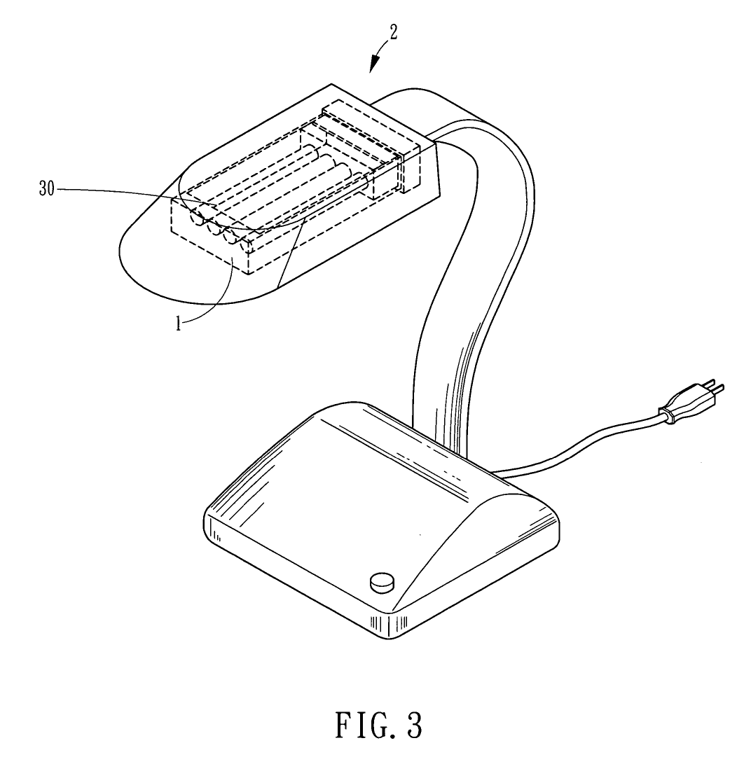

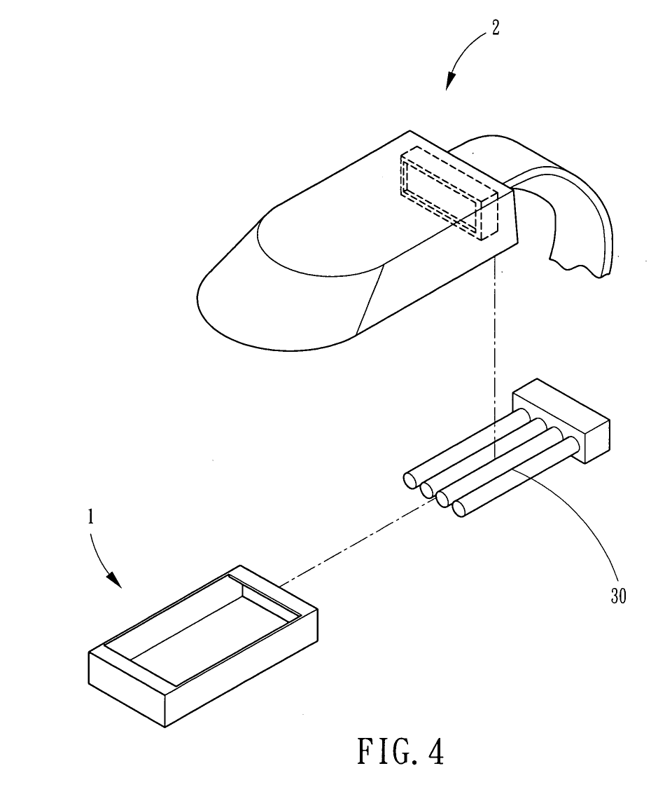

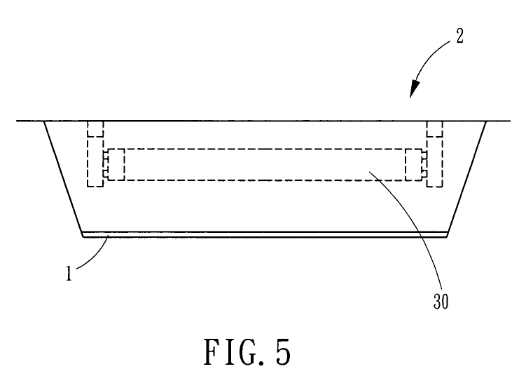

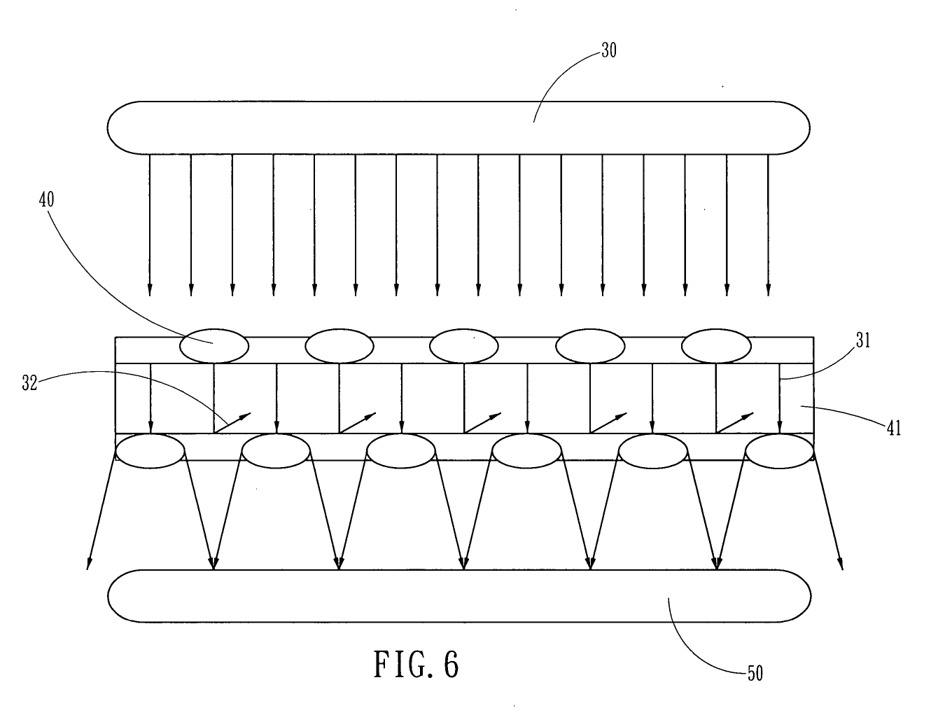

Referring to FIGS. 3 to 6, the device 1 is adapted to mount between lamps 30 (i.e., light source) and shade of a light (e.g., hanging pendant, ceiling lamp, corner lighting, or table lamp 2 in the embodiment). Rays of light emitted from the lamps 30 passes through the device 1 prior to reaching the object to be lit. Fortunately, the device 1 can cause the reduction of luminance and brightness to a minimum. In detail, as shown in FIG. 6 specifically, most rays of light emitted from the lamps 30 impinge on a plurality of small areas 40 on the inner optical layer 20. The areas 40 function as convex lenses for spreading rays of light. As such, subtle rays of light pass the substrate 10 to reach a plurality of small areas 40 on the outer optical layer 20 while glare is reflected. Again, the areas 40 function as convex lenses for spreading rays of light. As a result, a reading area 50 is evenly lit by rays of light with increased while stable luminance and brightness.

Following is an experiment conducted in a dark room with respect to a table lamp incorporated the anti-glare device 1 (the invention) and a typical table lamp (prior art). In detail, each of the table lamps is placed on a sheet of paper (e.g., A3). The lamps 30 of the table lamp are adjusted to be parallel with the sheet of paper. Relative to a base point by a predetermined distance, a plurality of test points are set in a plurality of rows and columns wherein each point is spaced apart from an adjacent point of the same row or column by 5 cm as illustrated below.

| | |
|---|---|
| | (1) |
| 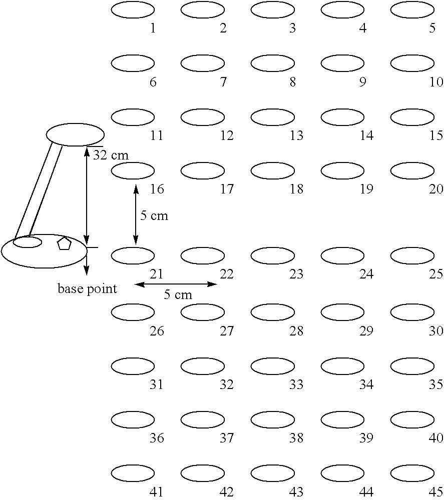 | |

Following is a table showing data of luminance measured on the sheet of paper with respect to the invention and prior art after turning on the invention and prior art respectively. The luminance is expressed in the unit of LUX.

(3)

| | | | | | | | | | | |
|---|---|---|---|---|---|---|---|---|---|---|
| The | 1 | 1142 | 2 | 1198 | 3 | 1128 | 4 | 938 | 5 | 691 |
| invention | | | | | | | | | | |
| Prior art | 1 | 1277 | 2 | 1304 | 3 | 1169 | 4 | 1074 | 5 | 936 |
| The | 6 | 1542 | 7 | 1613 | 8 | 1493 | 9 | 1288 | 10 | 955 |
| invention | | | | | | | | | | |
| Prior art | 6 | 1527 | 7 | 1511 | 8 | 1372 | 9 | 1220 | 10 | 1035 |
| The | 11 | 1940 | 12 | 1850 | 13 | 1760 | 14 | 1496 | 15 | 1160 |
| invention | | | | | | | | | | |
| Prior art | 11 | 1716 | 12 | 1726 | 13 | 1661 | 14 | 1395 | 15 | 1176 |
| The | 16 | 2100 | 17 | 2070 | 18 | 1910 | 19 | 1661 | 20 | 1324 |
| invention | | | | | | | | | | |
| Prior art | 16 | 1835 | 17 | 1820 | 18 | 1691 | 19 | 1456 | 20 | 1195 |
| The | 21 | 2120 | 22 | 2130 | 23 | 1920 | 24 | 1730 | 25 | 1352 |
| invention | | | | | | | | | | |
| Prior art | 21 | 1717 | 22 | 1723 | 23 | 1608 | 24 | 1408 | 25 | 1194 |
| The | 26 | 2000 | 27 | 2000 | 28 | 1985 | 29 | 1717 | 30 | 1280 |
| invention | | | | | | | | | | |
| Prior art | 26 | 1798 | 27 | 1740 | 28 | 1618 | 29 | 1425 | 30 | 1219 |
| The | 31 | 1901 | 32 | 1901 | 33 | 1786 | 34 | 1511 | 35 | 1206 |
| invention | | | | | | | | | | |
| Prior art | 31 | 1609 | 32 | 1651 | 33 | 1520 | 34 | 1344 | 35 | 1160 |
| The | 36 | 1641 | 37 | 1585 | 38 | 1509 | 39 | 1310 | 40 | 1051 |
| invention | | | | | | | | | | |
| Prior art | 36 | 1461 | 37 | 1410 | 38 | 1326 | 39 | 1211 | 40 | 1028 |
| The | 41 | 1220 | 42 | 1225 | 43 | 1170 | 44 | 993 | 45 | 844 |
| invention | | | | | | | | | | |
| Prior art | 41 | 1218 | 42 | 1165 | 43 | 1072 | 44 | 1020 | 45 | 916 |

Following is another table showing data of average luminance by sampling luminance data on different measured points of the sheet of paper with respect to the invention and prior art respectively. The luminance is also expressed in the unit of LUX.

(2)

distance

| shade | 5 cm | 10 cm | 20 cm |
|---|---|---|---|
| The invention | 1975 | 1958 | 1624 |
| Prior art | 1714 | 1696 | 1467 |

In view of the above experiment, it is found that the anti-glare device 1 of the invention can not only increase luminance and brightness but also significantly reduce glare and reflections.

While the invention herein disclosed has been described by means of specific embodiments, numerous modifications and variations could be made thereto by those skilled in the art without departing from the scope and spirit of the invention set forth in the claims.

1. An anti-glare device mounted around one or more light sources in a shade of a lamp, comprising:
a substrate formed of transparent plastic; and
two optical layers formed on inner and outer surfaces of the substrate respectively.

2. The anti-glare device of claim 1, wherein the plastic is PET.

3. The anti-glare device of claim 1, wherein the plastic is PC.

4. The anti-glare device of claim 1, wherein the plastic is teflon.

5. The anti-glare device of claim 1, wherein the plastic is acrylic.

6. The anti-glare device of claim 1, wherein the base is thin and has a shape of parallelepiped with an open top surface.

7. The anti-glare device of claim 1, wherein each of the optical layers is formed by coating.

8. The anti-glare device of claim 1, wherein each of the optical layers is formed by spraying.

9. The anti-glare device of claim 1, wherein each of the optical layers is formed by UV impinging.

10. The anti-glare device of claim 1, wherein each of the optical layers is formed by printing.
